(19) United States
(12) Patent Application Publication
(10) Pub. No.: US 2002/0052826 A1
(43) Pub. Date: May 2, 2002

(54) Sales transactions for transfer of agricultural products

(76) Inventors: David Dines, Wayzata, MN (US); Mark Tracy, Minneapolis, MN (US); Joseph Stone, Petit Lancy (CH); Dennis Inman, Eden Prairie, MN (US); Jeffrey Seeley, Chanhassen, MN (US)

Correspondence Address: SHUMAKER & SIEFFERT, P. A., 8425 SEASONS PARKWAY, SUITE 105, ST. PAUL, MN, 55125, US

(21) Appl. No.: 09/862,994

(22) Filed: May 22, 2001

Related U.S. Application Data
(60) Provisional application No. 60/245,318, filed on Nov. 2, 2000.

(51) Int. Cl. G06F 17/60

(52) U.S. Cl. 705/37

(57) ABSTRACT

A method for transacting exchanges of agricultural products, such as crop output, livestock, and animal produce, includes setting a first price for a first quantity of agricultural product based on an average price observed during a period of time and either a premium or discount to the average price. A second price is set for a second quantity of an agricultural product based on a price determined at a future date. The second price does not exceed a maximum price in the event a premium applies to the first quantity, or a minimum price in the event a discount applies to the first quantity. The first quantity and the second quantity are delivered from a seller to a buyer, and the seller is paid a sum based on the first price, the premium or discount, as applicable, and the second price.

This application claims priority from U.S. provisional application No. 60/245,318, filed Nov. 2, 2000, the entire content of which is incorporated herein by reference.

### TECHNICAL FIELD

The invention relates to the agriculture business and, more particularly, to transactions involving the exchange of agricultural products as market commodities.

### BACKGROUND

Agricultural producers face substantial risks in producing an agricultural product, bringing it to market, and earning a profit. Individual farmers, for example, are especially susceptible to risk factors that can adversely affect yield, marketability, and market price. Risk factors include weather conditions such as drought, hail, wind, frost, and excess rain, plant disease, insects, market volatility, increased global capacity, and government regulations. To offset some of the risks associated with market volatility, many producers enter into marketing agreements with buyers of agricultural products.

Marketing agreements often set prices based on futures prices, i.e., a futures price for a contract month, such as “December corn futures.” Marketing agreements may also include quantity requirements, price floors, and price ceilings. With a marketing agreement, the agricultural producer may achieve some level of comfort in his ability to market products at a reasonable price. The marketing agreement thereby reduces the agricultural producer's vulnerability to price risks that can cut into profits and even drive him out of business. In return, the buyer achieves access to a predetermined quantity of product, and is able to hedge the implicit risks associated with the price obligations in the marketing agreement.

### SUMMARY

The invention is directed to a method for transacting exchanges of agricultural products. The exchange may be transacted between a buyer and an agricultural producer, or between a buyer and a seller who is not an agricultural producer. A seller, other than an agricultural producer, may be an entity that buys agricultural products from an agricultural producer (or another reseller) and then resells the products to another buyer. Thus, a buyer may contract directly with an agricultural producer or with an intermediary in the form of a buyer/reseller of agricultural products.

The invention presents techniques by which a buyer and a seller may allocate their respective risks. The buyer guarantees an average price for a first quantity of a first agricultural product. In addition to the average price for the first quantity, the buyer guarantees a premium over the average, or the seller guarantees a discount under the average, depending upon variable pricing requirements applicable to a second quantity of a second agricultural product. The first and second agricultural products may be different agricultural products, such as corn and soybeans, or they may be the same agricultural product.

In one embodiment, the invention provides a method for transacting exchanges of agricultural products, the method comprising setting a first price for a first quantity of a first agricultural product based on an average price observed during a period of time and a premium above the average price, setting a second price for a second quantity of a second agricultural product based on a price determined at a future date, wherein the second price is capped so as to not exceed a maximum price, delivering both the first quantity and the second quantity from a seller to a buyer, and paying the seller a sum based on the first price, the premium, and the second price.

In another embodiment, the invention provides a method for transacting exchanges of agricultural products, the method comprising setting a first price for a first quantity of a first agricultural product based on an average price observed during a period of time and a discount to the average price, setting a second price for a second quantity of a second agricultural product based on a price determined at a future date, wherein the second price is floored so as not to drop below a minimum price, delivering both the first quantity and the second quantity from a seller to a buyer, and paying the seller a sum based on the first price, the discount, and the second price.

The methods can provide an agricultural producer or other seller or reseller of agricultural products with greater price certainty in exchange for delivery of both the first and second quantities of agricultural product. In addition, the methods can provide the agricultural producer with a premium or a guaranteed minimum price. In return, the buyer benefits from greater certainty with respect to quantity, and can hedge the implicit risks associated with the price obligations.

In one embodiment, the price calculation for the first quantity is based on an average price and includes a premium, while the price calculation for the second quantity may be based on a futures price and is subject to a maximum level. In an alternative embodiment, instead of a premium, the first price may be subject to a discount, in which case the price for the second amount is subject to a minimum price level.

In another embodiment, the seller must deliver the second quantity to the buyer in order to receive the premium for the first quantity, particularly if regulatory requirements mandate such delivery. In other embodiments, delivery of the second quantity may be optional. In either case, delivery need not be physical, and may refer to any other form of legal transfer of ownership directly or indirectly from producer or reseller to buyer. However, the agreement still is tied to a physical quantity of agricultural product, i.e., at least the first quantity. The method makes use of first and second quantities with different price calculations that better balance the risk between the seller and buyer. In addition, the method ensures that more actual underlying product is exchanged between the seller and the buyer. In this manner, the buyer and seller both benefit from the arrangement.

The details of one or more embodiments of the invention are set forth in the the description below. Other features, objects, and advantages of the invention will be apparent from the description, and from the claims.

### BRIEF DESCRIPTION OF THE DRAWINGS

FIG. 1 is a diagram illustrating the interaction between an agricultural producer and a buyer according to an embodiment of the invention.

FIG. 2 is a diagram illustrating the interaction between an agricultural producer and a buyer according to another embodiment of the invention.

### DETAILED DESCRIPTION

In accordance with the invention, a method for transacting exchanges of agricultural products includes setting a first price for a first quantity of a first agricultural product. The first price is based on an average price observed during a period of time and either a premium or discount to the average price. Thus, the first price and premium or discount are combined and applied to the first quantity to produce a first amount that is payable to the seller by a buyer, e.g., upon delivery of the first quantity.

The amount payable is not necessarily the cash price, i.e., the sum actually paid to the seller. The cash price reflects the agreed-upon price for the commodity, but the cash price may also be adjusted for basis. The cash price may be further adjusted for factors such as quality.

A second price is set for a second quantity of a second agricultural product. The second agricultural product may be the same as the first agricultural product, for example, both the first and second agricultural products may be corn. Alternatively, the first and second agricultural products may be different agricultural products, such as corn and soybeans. Unlike the first price, however, the second price is based on a price determined at a future date. The second price may be, for example, a futures price.

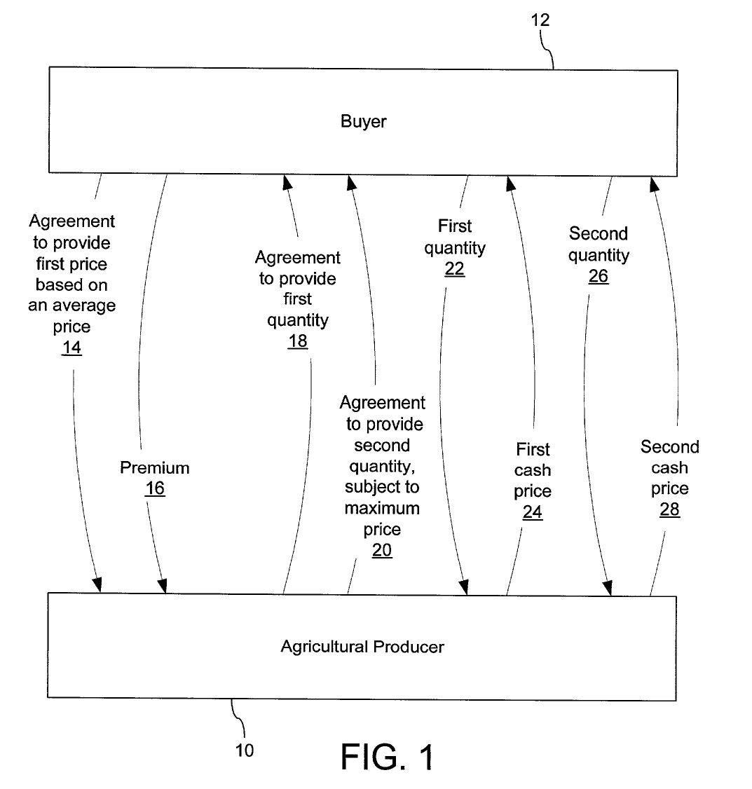

FIG. 1 illustrates a typical arrangement in accordance with the invention. Buyer 12 agrees to buy a first quantity of an agricultural product from a seller, agricultural producer 10, at a first price based on an average price observed during a period of time (14). Buyer 12 further agrees to pay to agricultural producer 10 a premium above the average price (16). In return, agricultural producer 10 agrees to provide the first quantity at the first price (18). Agricultural producer 10 further agrees to provide the second quantity at the second price, based on a futures price. In addition, the second price is capped so as not to exceed a maximum price (20). Thus, in the event the futures price exceeds the maximum price, the second price is capped at the maximum price. The second price is applied to the second quantity to determine a second amount payable to agricultural producer 10 by buyer 12.

As a condition to receipt of the first amount, and thus the premium, agricultural producer 10 must deliver both the first quantity (22) and the second quantity (26), assuring buyer 12 a predefined quantity level. In exchange, buyer 12 must pay agricultural producer 10 cash prices based on the first and second amounts, which are based on application of the sum of the first price and the premium to the first quantity (24) and application of the second price to the second quantity (28).

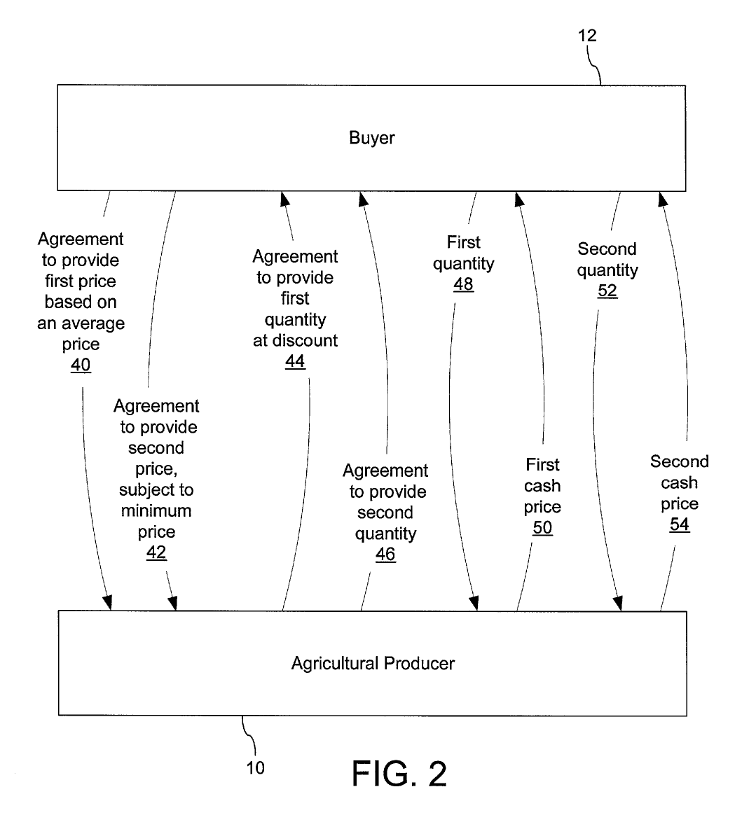

FIG. 2 illustrates an alternate arrangement in accordance with the invention, in which the second price is floored so as not to go below a minimum price. Buyer 12 agrees to buy a first quantity of an agricultural product from agricultural producer 10 at a first price based on an average price observed during a period of time (40). Agricultural producer 10 agrees to provide the first quantity at the first price, which includes a discount (44). Buyer 12 further agrees to pay to agricultural producer 10 a second price for a second quantity, subject to a minimum price (42), and agricultural producer 10 agrees to provide the second quantity (46).

Agricultural producer 10 must deliver both the first quantity and the second quantity (48, 52), assuring buyer 12 a predefined quantity level. In exchange, buyer 12 must pay agricultural producer 10 cash prices based on the first and second amounts (50, 54). Agricultural producer 10 accepts an average price on the first quantity, less a discount. In return, buyer 12 guarantees agricultural producer 10 a minimum price for the second quantity, which may exceed the market price.

The term “agricultural producer” may refer to any producer of agricultural products, from an individual farmer to a large corporate farming operation. “Product” produced by the agricultural producer may take the form of crops such as grain, larger vegetables, fruit, cotton, and the like, livestock or animal produce, as well as any byproducts of foregoing products that may be traded as commodities.

A “buyer” may take the form of a grain elevator, processing plant, or other point of delivery for a producer's output, an integrated agricultural products provider, or an entity or collection of entities that purchase agricultural products and trades agricultural commodities and options on the open market. A “seller” may be an agricultural producer or any entity that buys agricultural products from an agricultural producer or elsewhere and resells them to a buyer. Thus, the seller may be a reseller or “middleman” who trades in agricultural products.

An agreement in support of the transaction may be between an agricultural producer and a buyer, or between a buyer/reseller and a buyer. Thus, a buyer/reseller may have contractual obligations to both the buyer and the producer, and can be viewed as an intermediary.

A method in accordance with the present invention provides an alternative to sellers and buyers. It provides an additional premium over or discount below an average price observed during a given time frame for an initial quantity exchanged. In addition, it provides an opportunity to earn some limited benefit from price changes affecting a second quantity committed at the same time.

To make the premium or discount feasible, the buyer and seller agree to exchange an initial “first” quantity and pay the average (plus or minus the premium or discount) of an observed price over a known period. Also, the buyer and seller agree to transact an exchange of the second quantity at a price to be determined. The price for the second quantity may be determined by reference to any mutually agreed upon index for the particular commodity, such as a futures price.

In consideration of a premium paid to the seller, the price for the second quantity may be made subject to a maximum price level. In this case, the seller benefits from the premium on the first quantity while the buyer benefits from a price ceiling on the second quantity.

In consideration of the discount, the price of the second quantity may be subject to a minimum price level. In this case, the seller benefits from a price floor on the second quantity while the buyer benefits from the discount on the first quantity.

In this manner, a buyer's customer, e.g., an agricultural producer, can get paid the average plus a known premium. Conversely, a seller's customer, e.g., an agricultural commodities trader, can acquire at the average less the known discount. In either case, the price level for the second quantity is determined by another price structure and is subject to the minimum price level in the case of a discount or the maximum price level in the case of a premium.

Notably, there is no limit on how high or low the average price may go for purposes of calculating the first price for the first quantity. In addition, two distinct methods are used to price the first and second quantities. There is no option on the part of the buyer or seller to take or make delivery of the first quantity. In addition, for regulatory compliance, there ordinarily will be no option to take or make delivery of the second quantity. Rather, delivery of both quantities at the agreed upon prices ordinarily will be mandatory under the agreement. If regulatory requirements permit, however, it is conceivable that delivery of the second quantity may be optional and determined by the level of the second price at the time of delivery or some other time agreed upon by the parties.

The premium or discount may be above, equal to, or below the predefined average depending on the specifics of a particular agricultural product or combination of products. The premium or discount may be paid and received at any time agreed upon by the buyer and seller. Timing of the payment could result, for example, in implicit financing revenue or cost to either or both parties.

As further distinctions, the method need not result in indemnified profit sharing between the buyer and seller. Instead, it guarantees a premium over the average or a discount under the average for the first quantity, in consideration of variable pricing requirements applicable to the second quantity. The pricing structure for the second quantity presents a risk to both the buyer and seller.

According to the invention, a contract between the parties may include:

(a) A first agreement for a buyer and seller to receive and pay, respectively, the average price observed during a given time frame plus a premium or minus a discount for an initial quantity. The calculation method for the average price is predefined and no boundaries on the averaging points need exist.

(b) A mandatory second agreement, made simultaneously and inseparable from the first agreement, providing that in exchange for the premium or discount, as the case may be, the buyer and seller will receive and deliver, respectively, a second quantity based on a price to be known at a future date. The price at the future date may be limited to a maximum in the case a premium is applied to the first quantity, or a minimum in the case a discount is applied to the first quantity.

To establish the average price, the parties may agree to a readily observable price with known observation times, dates, and other conditions. For example, the parties may agree to observe the price every day, every other day, every week, every month, on selected dates, and so forth. Any observable price may be used. Exchange-based futures prices are a common source of averaging points, and are suitable for this calculation. The parties may agree, for example, that the observed price on a particular day shall be the closing price on the exchange that day. Other indices of average price may be used.

The parties may agree to calculate the average price in many ways. Typically, the parties would use the arithmetic mean, but they may agree to other methods of calculation, such as a weighted average or a median or a mode.

To create the maximum or minimum price, the parties may additionally commit to a pricing structure that may resemble an American or European option. The date and time of the beginning and ending of the averaging period for the first quantity and the pricing structure for the second quantity are determined at the time of contracting.

As an example, assume that the date is Apr. 2, 2002 and that Dec. 2002 corn futures at the Chicago Board of Trade are trading at 255.00 (cents per bushel). Also assume that a farmer wants to sell corn to an elevator for future delivery in Sep. 2002. For a first quantity of his expected crop, e.g., a first half, the farmer would like to earn a premium in excess of the average price observed from Apr. through Sep. 16, 2002. The farmer also would like to have a confirmed agreement to sell a second quantity of the crop, e.g., a second half, at the prevailing market price on Sep. 16, 2002.

The farmer believes that market prices are unlikely to be above 275.00 on Sep. 16, 2002, but considers that to be a desirable price for the second half of the crop. Therefore, he is willing to forego potential gains above 275.00 on the second half of the crop, in exchange for a guaranteed premium of ten cents per bushel above the average for the first half of the crop. Thus, for this example, the farmer agrees to exchange the first half of the crop at the average plus the premium, and the second half of the crop at the ending price subject to the maximum of 275.00.

In a first case, prices fall from 255.00 on Apr. 2, 2002 to 188.00 on Sep. 13, 2002, and the average over that period is 209.15. Application of the average of 209.15 to the first half of the crop is better than taking the ending value. Additionally, earning the extra ten cents premium above the average for the first half for a total of 219.15 is even better from the farmer's perspective. The second half of the crop earns the lower ending price of 188.00, but is buoyed by the price for the first half of the crop.

In a second case, prices rise from 255.00 to 256.00 between Apr. 2, 2002 and Sep. 13, 2002, and the average over that period is 252.90. In this case, earning the extra ten cents above the average for a total of 262.90 for the first half of the crop is better than both the beginning and ending prices, as well as the average. The second half of the crop is delivered at the ending price of 256.00, making for a rather successful marketing result for the farmer's total crop.

In a third case, prices rise from 255.00 to 276.00 between Apr. 2, 2002 and Sep. 13, 2002, and the average over that period is 273.26. The farmer is paid the average of 273.26 plus the ten cent premium for a total of 283.26 for the first half of the crop. The second half of the crop earns 275.00 because the ending price of 276.00 barely exceeded the agreed upon maximum of 275.00. In this case, the buyer benefits slightly from the maximum price applied to the second half of the crop.

In a fourth case, prices rise from 255.00 to 311.00 between Apr. 2, 2002 and Sep. 13, 2002, and the average over that period is 285.03. With the ten cent premium, the price for the first half of the crop is 295.03. The second half of the crop is the maximum of 275.00 as the ending price greatly exceeded the maximum. For this case, the buyer benefits significantly from the maximum price applied to the second half of the crop.

Scenarios similar to those above can be envisioned for an arrangement in which a seller and buyer agree that the first quantity will be subject to an average price minus a discount, and the second quantity will be an ending price subject to a minimum price. In some instances, the minimum will benefit the seller by insulating the second quantity against excessive downward price trends. In other instances, the discount provided to the buyer will compensate for excessive price increases.

The method is applicable to a variety of implementations. The method may be carried out manually, for example, between the buyer and seller of the agricultural products. It may be practiced at multiple levels in the supply channel, i.e., between agricultural producer and intermediate buyer, and then between the intermediate buyer (as seller) and a subsequent buyer. One or more intermediate buyers, such as grain elevator and intermediate grain trader are envisioned. The method may benefit from automation and aggregation at the intermediate level, permitting a trader situated upstream from an intermediate trader to take on an aggregation of contracts in accordance with the method rather than individual contracts with producers. Moreover, the confidentiality of the ultimate buyer or seller and the producer may be preserved. In particular, the intermediate buyer/reseller need not disclose their identities, providing the advantage of anonymity. A suitable delivery system for implementation of aggregation and anonymity is described in U.S. provisional application serial No. 60/245,403, to David E. Dines et al., entitled “Sales Transactions for Transfer of Agricultural Products,” filed Nov. 2, 2000.

A number of embodiments of the present invention have been described. Nevertheless, it will be understood that various modifications may be made without departing from the spirit and scope of the invention. Accordingly, other embodiments are within the scope of the following claims.

1. A method for transacting exchanges of agricultural products, the method comprising:
setting a first price for a first quantity of a first agricultural product based on an average price observed during a period of time and a premium above the average price;
setting a second price for a second quantity of a second agricultural product based on a price determined at a future date, wherein the second price is capped so as to not exceed a maximum price;
delivering both the first quantity and the second quantity from a seller to a buyer; and
paying the seller a sum based on the first price, the premium, and the second price.

2. The method of claim 1, wherein the first price is a per unit price X1, the premium is a per unit price Y1, the second price is a per unit price X2, the first quantity is Q1 units, the second quantity is Q2 units, and the sum paid to the seller is based on (X1+Y1)*Q1+X2*Q2.

3. The method of claim 1, wherein the seller is an agricultural producer.

4. The method of claim 1, wherein the buyer is a reseller of agricultural products.

5. The method of claim 1, wherein the agricultural products include grain.

6. The method of claim 1, wherein the agricultural products include livestock.

7. The method of claim 1, wherein the agricultural products include animal produce.

8. The method of claim 1, wherein the first agricultural product is the same as the second agricultural product.

9. A method for transacting exchanges of agricultural products, the method comprising:
setting a first price for a first quantity of a first agricultural product based on an average price observed during a period of time and a discount to the average price;
setting a second price for a second quantity of a second agricultural product based on a price determined at a future date, wherein the second price is floored so as not to drop below a minimum price;
delivering both the first quantity and the second quantity from a seller to a buyer; and
paying the seller a sum based on the first price, the discount, and the second price.

10. The method of claim 9, wherein the first price is a per unit price X1, the discount is a per unit price Y1, the second price is a per unit price X2, the first quantity is Q1 units, the second quantity is Q2 units, and the sum paid to the seller is based on (X1-Y1) *Q1+X2*Q2.

11. The method of claim 9, wherein the seller is an reseller of agricultural products.

12. The method of claim 9, wherein the buyer is a reseller of agricultural products.

13. The method of claim 9, wherein the agricultural products include grain.

14. The method of claim 9, wherein the agricultural products include livestock.

15. The method of claim 9, wherein the agricultural products include animal produce.

16. The method of claim 9, wherein the first agricultural product is the same as the second agricultural product.

17. A method for transacting exchanges of agricultural products, the method comprising:
setting a first price for a first quantity of a first agricultural product based on an average price observed during a period of time and a premium above the average price;
setting a second price for a second quantity of a second agricultural product based on a price determined at a future date, wherein the second price is capped so as not to exceed a maximum price;
delivering at least the first quantity from a seller to a buyer; and
paying the seller a sum based at least in part on the first price and the premium.

18. The method of claim 17, further comprising delivering both the first quantity and the second quantity from the seller to the buyer, and paying the seller a sum based on the first quantity, the first price, the second quantity, the second price, and the premium.

19. The method of claim 17, wherein the seller is an agricultural producer.

20. The method of claim 17, wherein the buyer is a reseller of agricultural products.

21. The method of claim 17, wherein the agricultural products include grain.

22. The method of claim 17, wherein the agricultural products include livestock.

23. The method of claim 17, wherein the agricultural products include animal produce.

24. The method of claim 17, wherein the first agricultural product is the same as the second agricultural product.

25. A method for transacting exchanges of agricultural products, the method comprising:
setting a first price for a first quantity of a first agricultural product based on an average price observed during a period of time and a discount above the average price;
setting a second price for a second quantity of a second agricultural product based on a price determined at a future date, wherein the second price is floored so as not to drop below a minimum price;
delivering at least the first quantity from a seller to a buyer; and
paying the seller a sum based at least in part on the first price and the discount.

26. The method of claim 25, further comprising delivering both the first quantity and the second quantity from the seller to the buyer, and paying the seller a sum based on the first quantity, the first price, the second quantity, the second price, and the discount.

27. The method of claim 25, wherein the seller is an agricultural producer.

28. The method of claim 25, wherein the buyer is a reseller of agricultural products.

29. The method of claim 25, wherein the agricultural products include grain.

30. The method of claim 25, wherein the agricultural products include livestock.

31. The method of claim 25, wherein the agricultural products include animal produce.

32. The method of claim 25, wherein the first agricultural product is the same as the second agricultural product.
